(19) United States
(12) Patent Application Publication
(10) Pub. No.: US 2017/0259563 A1
(43) Pub. Date: Sep. 14, 2017

(54) LIQUID DISCHARGE HEAD AND LIQUID DISCHARGE APPARATUS

(71) Applicant: SEIKO EPSON CORPORATION, Tokyo (JP)

(72) Inventor: Kinya OZAWA, Shiojiri-Shi (JP)

(21) Appl. No.: 15/447,369

(22) Filed: Mar. 2, 2017

(30) Foreign Application Priority Data
Mar. 10, 2016 (JP) 2016-046603

(51) Int. Cl. B41J 2/045; B41J 2/14

(52) U.S. Cl. CPC B41J 2/04588; B41J 2/04581; B41J 2/14233

(57) ABSTRACT

A liquid discharge head includes a liquid flow path, and a nozzle communicating with the liquid flow path and configured to allow a liquid flown in via the liquid flow path to be discharged from the nozzle itself. The nozzle includes a first nozzle portion at a side at which the liquid is discharged, and a second nozzle portion at a side of the liquid flow path. The first nozzle portion and the second nozzle portion respectively include a first partial region and a second partial region that do not overlap each other when viewed in a liquid discharge direction in which the liquid is discharged. After at least one portion of a meniscus inside the nozzle has reciprocated across a boundary between the first nozzle portion and the second nozzle portion one or more times, a liquid droplet is discharged from the nozzle.

### BACKGROUND

### 1. Technical Field

The present invention relates to a liquid discharge head mounted in a liquid discharge apparatus such as an ink jet recording apparatus, and to the liquid discharge apparatus. In particular, the invention relates to a liquid discharge head that allows its driving element to perform driving to cause a pressure vibration to arise in a liquid inside its liquid flow path so as to allow the liquid to be discharged from its nozzle, and to a liquid discharge apparatus including the liquid discharge head.

### 2. Related Art

A liquid discharge apparatus is an apparatus including a liquid discharge head and configured to allow various kinds of liquids to be discharged (ejected) from nozzles of the liquid discharge head. Such a liquid discharge apparatus is applied to an image recording apparatus, such as an ink jet printer and an ink jet plotter, and recently, such a liquid discharge apparatus is also applied to various manufacturing apparatus by leveraging its feature in that it is capable of allowing a very small amount of liquid to be landed at a predetermined position with accuracy. For example, such a liquid discharge apparatus is applied to a display manufacturing apparatus for use in manufacturing color filters for a liquid crystal display and the like, an electrode forming apparatus for use in forming electrodes for an organic electro luminescence display (organic EL display), a face emitting display (FED), and the like, and a tip manufacturing apparatus for use in manufacturing biotips (biologic elements). Further, a recording head for the image recording apparatus is configured to discharge inks in liquid form, and a color material discharge head for the display manufacturing apparatus is configured to discharge solutions for color materials colored in R (red), G(green), and B(blue). Further, an electrode material discharge head for the electrode forming apparatus is configured to discharge electrode materials in liquid form, and a living organic material discharge head for the tip manufacturing apparatus is configured to discharge solutions for living organic materials.

With respect to such a nozzle from which liquid droplets are discharged, not only a nozzle of a cylindrical shape, but also a nozzle of a tapered shape in which its flow-path cross-sectional area is gradually reduced in a direction from its inlet side (its liquid flow path side) toward its outlet side (its outside), a nozzle having a structure of multiple stages having mutually different flow-path cross-sectional areas, and any other nozzle having a devised structure have been proposed (for example, see WO 2008/155986). For the liquid discharge heads of this kind, a liquid droplet discharged from a nozzle is elongated in its flying direction and is brought into a state in which the liquid droplet has its tail. Hereinafter, this phenomenon will be referred to as a tail.

When a tail arises in a liquid droplet discharged from a nozzle, the liquid droplet is separated into its head portion and its portion behind the head portion (i.e., its tail portion), that is, separated into a head main liquid droplet (a main liquid droplet) and a satellite liquid droplet (a sub liquid droplet). Moreover, mists each being more minute than the satellite liquid arise. When the satellite liquid droplet is landed at a position different from that of the main liquid droplet on a landing target such as a recording medium, this phenomenon leads to the degradation of the quality of recorded images or the like. Further, the mists drift inside the apparatus without reaching the recording medium or the like, and stain the inside of the apparatus. Moreover, the mists having been adhered to easily charged components, such as a recording head and electric circuits, are likely to cause operation failures.

### SUMMARY

An advantage of some aspects of the invention is that a liquid discharge head and a liquid discharge apparatus are provided that reduce the occurrence of tails of liquid droplets discharged from nozzles, and reduce the occurrence of mists and the like.

According to a first aspect of the invention, a liquid discharge head includes a liquid flow path, and a nozzle communicating with the liquid flow path and configured to allow a liquid flown in via the liquid flow path to be discharged from the nozzle itself. The nozzle includes a first nozzle portion at a side at which the liquid is discharged, and a second nozzle portion at a side of the liquid flow path. The first nozzle portion and the second nozzle portion respectively include a first partial region and a second partial region that do not overlap each other when viewed in a liquid discharge direction in which the liquid is discharged. Further, after at least one portion of a meniscus inside the nozzle has reciprocated across a boundary between the first nozzle portion and the second nozzle portion one or more times, a liquid droplet is discharged from the nozzle.

According to this configuration, during a process when a liquid droplet is discharged from a nozzle, at least one portion of a meniscus reciprocates across the boundary between the first nozzle portion and the second nozzle portion, which respectively include the first partial region and the second partial region that do not overlap each other, one or more times, and as a result, a further complicated vibration is excited in a liquid inside the nozzle. With this further complicated vibration, a narrow portion between the meniscus and a head portion of the ink, which becomes the ink droplet after the discharge from the nozzle, is caused to swing (i.e., brought into an unstable state), and as a result, the narrow portion is made more cuttable. Accordingly, this configuration reduces the occurrence of the tail of the liquid droplet discharged from the nozzle, and reduces the occurrence of the satellite liquid droplet and the mists.

Further, in the above configuration, a configuration in which a virtual center axis along the liquid discharge direction in the first nozzle portion is located within a scope of the second nozzle portion when viewed in the liquid discharge direction is preferred to be employed.

According to this configuration, since the virtual center axis along the liquid discharge direction in the first nozzle portion is located within a scope of the second nozzle portion when viewed in the liquid discharge direction, the flying direction of the liquid droplet discharged from the nozzle is made stable. Thus, this configuration reduces the degradation of accuracy of the landing of the ink droplet on a landing target of the ink droplet.

According to a second aspect of the invention, a liquid discharge head includes a liquid flow path, and a nozzle communicating with the liquid flow path and configured to allow a liquid flown in via the liquid flow path to be discharged from the nozzle itself. The nozzle includes a first nozzle portion at a side at which the liquid is discharged, and a second nozzle portion at a side of the liquid flow path. A flow path of the first nozzle portion and a flow path of the second nozzle portion include mutually different cross-sectional shapes when viewed in a liquid discharge direction in which the liquid is discharged. Further, after at least one portion of a meniscus inside the nozzle has reciprocated across a boundary between the first nozzle portion and the second nozzle portion one or more times, a liquid droplet is discharged from the nozzle.

According to this configuration, the flow paths of the first nozzle portion and the second nozzle portion have mutually different cross-sectional shapes, and during a process when a liquid droplet is discharged from the nozzle, at least one portion of the meniscus reciprocates across the boundary between the first nozzle portion and the second nozzle portion one or more times, and as a result, a further complicated vibration is excited in a liquid inside the nozzle. With this further complicated vibration, a narrow portion between the meniscus and a head portion of the ink, which becomes the ink droplet after the discharge from the nozzle, is caused to swing (i.e., brought into an unstable state), and as a result, the narrow portion is made more cuttable. Accordingly, this configuration reduces the occurrence of the tail of the liquid droplet discharged from the nozzle, and reduces the occurrence of the satellite liquid droplet and the mists.

Further, in the above configuration, a configuration in which the whole of the first nozzle portion is located within a scope of the second nozzle portion when viewed in the liquid discharge direction in the first nozzle portion may be employed.

According to this configuration, since the whole of the first nozzle portion is located within a scope of the second nozzle portion when viewed in the liquid discharge direction in the first nozzle portion, the flying direction of the liquid droplet discharged from the nozzle is made stable. Thus, this configuration reduces the degradation of accuracy of the landing of the ink droplet on a landing target of the ink droplet.

Further, according to a third aspect of the invention, a liquid discharge head includes a liquid flow path, and a nozzle communicating with the liquid flow path and configured to allow a liquid flown in via the liquid flow path to be discharged from the nozzle itself. The nozzle includes a first nozzle portion at a side at which the liquid is discharged, and a second nozzle portion at a side of the liquid flow path. The first nozzle portion is included within a scope of the second nozzle portion when viewed in a liquid discharge direction in which the liquid is discharged, and the first nozzle portion is eccentric to a virtual center axis along the liquid discharge direction in the second nozzle portion. Further, after at least one portion of a meniscus inside the nozzle has reciprocated across a boundary between the first nozzle portion and the second nozzle portion one or more times, a liquid droplet is discharged from the nozzle.

According to this configuration, the first nozzle portion is included within a scope of the second nozzle portion when viewed in a liquid discharge direction in which the liquid is discharged, and the first nozzle portion is eccentric to a virtual center axis along the liquid discharge direction in the second nozzle portion. Further, during a process when a liquid droplet is discharged from the nozzle, at least one portion of a meniscus reciprocates across the boundary between the first nozzle portion and the second nozzle portion one or more times, and as a result, a further complicated vibration is excited in a liquid inside the nozzle. With this further completed vibration, a narrow portion between the meniscus and a head portion of the ink, which becomes the ink droplet after the discharge from the nozzle, is made more cuttable. Accordingly, this configuration reduces the occurrence of the tail of the liquid droplet discharged from the nozzle, and reduces the occurrence of the satellite liquid droplet and the mists.

Further, in the above configuration, a configuration in which the flow path of the first nozzle portion includes a perfectly circular shape when viewed in the liquid discharge direction is preferred to be employed.

According to this configuration, since the flow path of the first nozzle portion includes a perfectly circular shape when viewed in the liquid discharge direction, the flying direction of the liquid droplet discharged from the nozzle is made stable. Thus, this configuration reduces the degradation of accuracy of the landing of the ink droplet on a landing target of the ink droplet.

According to a fourth aspect of the invention, a liquid discharge apparatus includes any one of the above liquid discharge heads configured in such ways described above, a driving element configured to cause a pressure vibration in a liquid inside the liquid flow path, which is included in the liquid discharge head, and a driving pulse generation circuit configured to generate a driving pulse that drives the driving element. The driving pulse includes a first drawing element that draws at least one portion of the meniscus, which is the meniscus of the any one of the above liquid discharge heads, from a side of the first nozzle portion, which is the first nozzle portion of the any one of the above liquid discharge heads, which is the second nozzle portion of the any one of the above liquid discharge heads, a first pushing out element that pushes out the meniscus from the first nozzle portion to an outside of the first nozzle portion, a second drawing element that draws again at least one portion of the meniscus from the side of the first nozzle portion to the side of the second nozzle portion, and a second pushing out element that pushes out the meniscus from the first nozzle portion to the outside of the first nozzle portion.

This configuration enables a liquid droplet to be discharged from the nozzle after allowing the first drawing element and the second drawing element to cause at least one portion of the meniscus to reciprocate across the boundary between the first nozzle portion and the second nozzle portion twice.

### BRIEF DESCRIPTION OF THE DRAWINGS

The invention will be described with reference to the accompanying drawings, wherein like numbers reference like elements.

FIG. 1 is a front view of a printer illustrating an internal configuration of the printer.

FIG. 2 is a block diagram illustrating an electric configuration of the printer.

FIG. 3 is a cross-sectional view of a recording head illustrating a configuration of the recording head.

FIG. 4 is a plan view of a nozzle illustrating a configuration of the nozzle.

FIG. 5 is a cross-sectional view of the nozzle taken along the line V-V of FIG. 4.

FIG. 6 is a cross-sectional view of the nozzle taken along the line VI-VI of FIG. 4.

FIG. 7 is a waveform diagram illustrating a configuration of a driving pulse.

FIG. 8 is a diagram illustrating a process in which a liquid droplet is discharged from a nozzle.

FIG. 9 is a diagram illustrating a process in which a liquid droplet is discharged from a nozzle.

FIG. 10 is a diagram illustrating a process in which a liquid droplet is discharged from a nozzle.

FIG. 11 is a diagram illustrating a process in which a liquid droplet is discharged from a nozzle.

FIG. 12 is a diagram illustrating a process in which a liquid droplet is discharged from a nozzle.

FIG. 13 is a diagram illustrating a process in which a liquid droplet is discharged from a nozzle.

FIG. 14 is a diagram illustrating a process in which a liquid droplet is discharged from a nozzle.

FIG. 15 is a diagram illustrating a process in which a liquid droplet is discharged from a nozzle.

FIG. 16 is a diagram illustrating a process in which a liquid droplet is discharged from a nozzle.

FIG. 17 is a plan view of a nozzle in a second embodiment.

FIG. 18 is a plan view of a nozzle in a third embodiment.

FIG. 19 is a plan view of a nozzle in a fourth embodiment.

FIG. 20 is a plan view of a nozzle in a fifth embodiment.

FIG. 21 is a plan view of a nozzle in a sixth embodiment.

### DESCRIPTION OF EXEMPLARY EMBODIMENTS

Hereinafter, embodiments to practice the invention will be described with reference to the accompanying drawings. It should be noted that embodiments described below are subjected to various limitations as preferred specific examples of the invention, but in description below, the scope of the invention is not limited to these embodiments unless particularly stated that the scope of the invention is limited. Further, in the following description, an ink jet recording apparatus (hereinafter referred to as a printer) will be described as an example of the liquid discharge apparatus according to the invention.

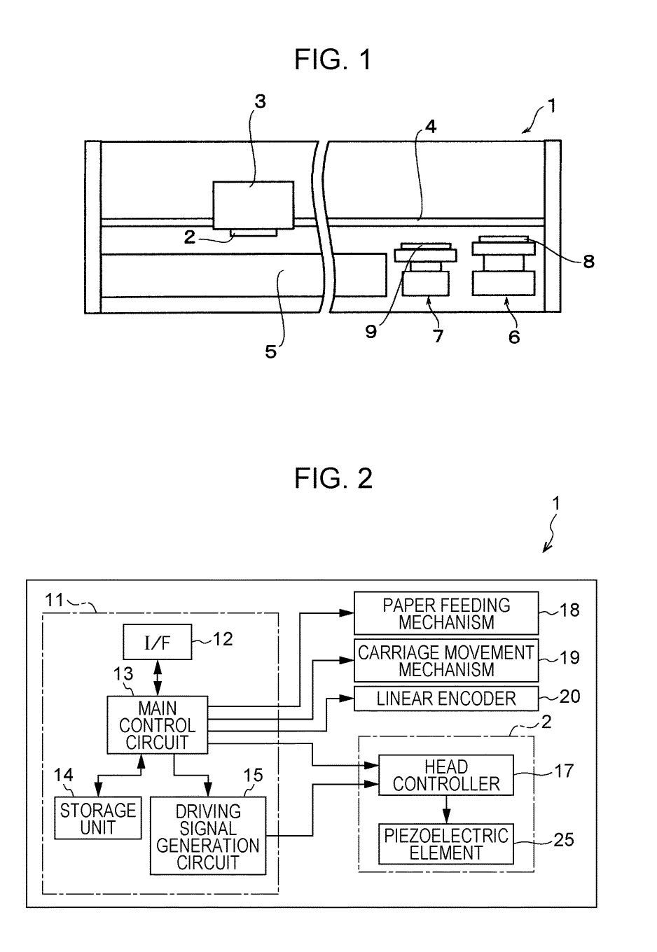

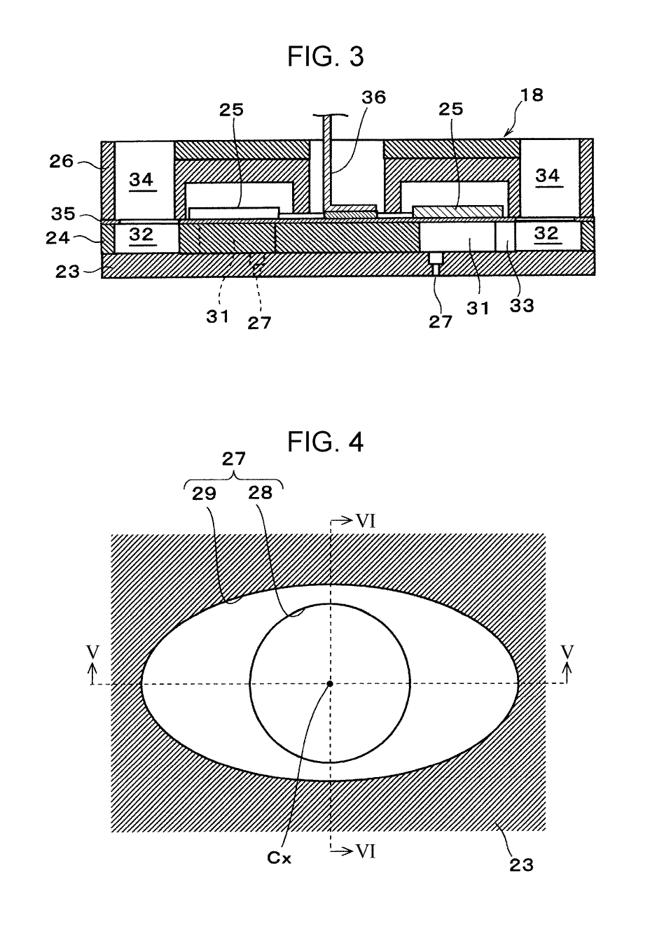

FIG. 1 is a front view of a printer 1 illustrating an internal configuration of the printer 1, and FIG. 2 is a block diagram illustrating an electric configuration of the printer 1. A recording head 2, one kind of liquid discharge heads, is attached to the bottom face side of a carriage 3. Further, this carriage 3 mounts ink cartridges (liquid supply sources), and is configured to be capable of reciprocating along a guide rod 4 by a carriage movement mechanism 19. That is, the printer 1 records an image and/or any other recording target on a recording medium in a way that allows the recording head 2 to be moved relative to the recording medium in a width direction (a main-scanning direction) of the recording medium in conjunction with the sequential transport of the recording medium on a platen 5 by a paper feeding mechanism 18 (see FIG. 2), and that allows inks, one kind of liquids, to be discharged from nozzles 27 (see FIG. 3) of the recording head 2 and landed onto the recording medium. Here, a configuration in which the ink cartridges are disposed at a side of the body of the printer and the inks contained in the ink cartridges are supplied to a side of the recording head 2 through supply tubes may be employed.

A home position, a waiting position of the recording head 2, is set at a position at one outside of the platen 5 (the right side in FIG. 2) in the main-scanning direction. At this home position, a capping mechanism 6 and a wiping mechanism 7 are disposed in series from one side toward the other side of the printer 1. The capping mechanism 6 includes a cap 8, and is configured to be capable of being brought to a state (a capping state) in which the cap 8 is in contact with and shields a nozzle face (a nozzle plate 23 described below) of the recording head 2, or of being brought to a waiting state in which the cap 8 is isolated from the nozzle face. The wiping mechanism 7 is configured to be capable of being brought to a state in which the wiper 12 is in contact with the nozzle face of the recording head 2, or of being brought to a waiting state in which a wiper 9 is isolated from the nozzle face. Any one of variously configured types of wipers may be employed as the wiper 9. Here, for example, a wiper having a structure in which the surface of its blade body having elasticity is covered by cloth is used as the wiper 9. The wiping mechanism 7 allows the wiper 9 to slide on and wipe the nozzle face in a state in which the wiper 9 is contact with the nozzle face.

The printer 1, according to this embodiment, allows a printer controller 11 to control individual portions of the printer 1. The printer 1, according to this embodiment, includes an interface (I/F) unit 12, a main control circuit 13, a storage unit 14, and a driving signal generation circuit 15 (corresponding to a driving pulse generation circuit in appended claims). The interface unit 12 receives printing data and a printing command to the printer 1 from external devices, such as a computer and a mobile information terminal, and outputs status information in relation to the printer 1 to an external device side. The storage unit 14 is an element for storing therein a program executed by the main control circuit 13 and data for use in its various controls, and includes ROM, RAM, and a non-volatile memory element (NVRAM).

The main control circuit 13 controls the individual units in accordance with the program stored in the storage unit 14. Further, the main control circuit 13, in this embodiment, generates pieces of discharge data each indicating at which timing point which of the inks to be discharged from which of the nozzles 27 (see FIG. 3, FIG. 4, and any other figure) on the basis of the printing data from the external device, and transmits the generated pieces discharge data to a head controller 17 of the recording head 2. Further, the main control circuit 13 generates timing pulses PTS from encoder pulses output from a linear encoder 20. Further, the main control circuit 13 controls the transfer of the printing data, the generation of driving signals by the driving signal generation circuit 15, and any other operation in synchronization with the timing pulses PTS. Further, the main control circuit 13 generates timing signals, such as a latch signal LAT, on the basis of the timing pulses PTS, and outputs the generated timing signals to the head controller 17 of the recording head 2. The head controller 17 selectively applies the driving signals to piezoelectric elements 25 on the pieces of discharge data and the timing signals. This selective application of the driving signals drives selected piezoelectric elements 25 among the piezoelectric elements 25 to allow each of the selected piezoelectric elements 25 to discharge an ink droplet from a corresponding one of the nozzles 27 or perform a slight vibration to a degree that does not cause the ink droplet to be discharged. The driving signal generation circuit 15 generates driving pulses (described below) that allow ink droplets to be discharged onto a recording medium so as to allow an image and/or any other recording target to be recorded on the recording medium.

Further, as shown in FIG. 2, the printer 1, in this embodiment, includes the paper feeding mechanism 18, the carriage movement mechanism 19, the linear encoder 20, the recording head 2, and any other component. The carriage movement mechanism 19 is constituted by the carriage 3, which mounts the recording head 2 therein, a driving motor (for example, a DC motor) (not illustrated), and any other component, and allows the recording head 2, which is mounted in the carriage 3, to move in the main-scanning direction. The paper feeding mechanism 18 is constituted by a paper feeding motor, a paper feeding roller (these being not illustrated), and any other component, and performs sub-scanning while sequentially feeding the recording medium on the platen 5. Further, the linear encoder 20 outputs encoder pulses being in accordance with the scanning position of the recording head 2, which is mounted in the carriage 3, and indicating position information in the main-scanning direction, to the printer controller 11. The main control circuit 13 of the printer controller 11 grasps the scanning position (the current position) of the recording head 2 on the basis of the encoder pulses received from the side of the linear encoder 20.

Next, a configuration of the recording head 2 will be described.

FIG. 3 is a main portion cross-sectional view of the recording head 2 illustrating an internal configuration of the recording head 2.

The recording head 2, in this embodiment, is mainly constituted by a nozzle plate 23, a flow path substrate 24, and piezoelectric elements 25, and is secured to a holder 26 in a state in which these members are stacked. The nozzle plate 23 is a member which is formed of a silicon single crystal substrate and in which a plurality of nozzles 27 are formed so as to be arranged in rows at predetermined pitches in the same direction so as to penetrate the member. In this embodiment, the plurality of nozzles 27 are arranged in parallel to one another, and constitute nozzle rows. Further, the inks are discharged from one side of the nozzle plate 23, and the face of this side corresponds to a nozzle face.

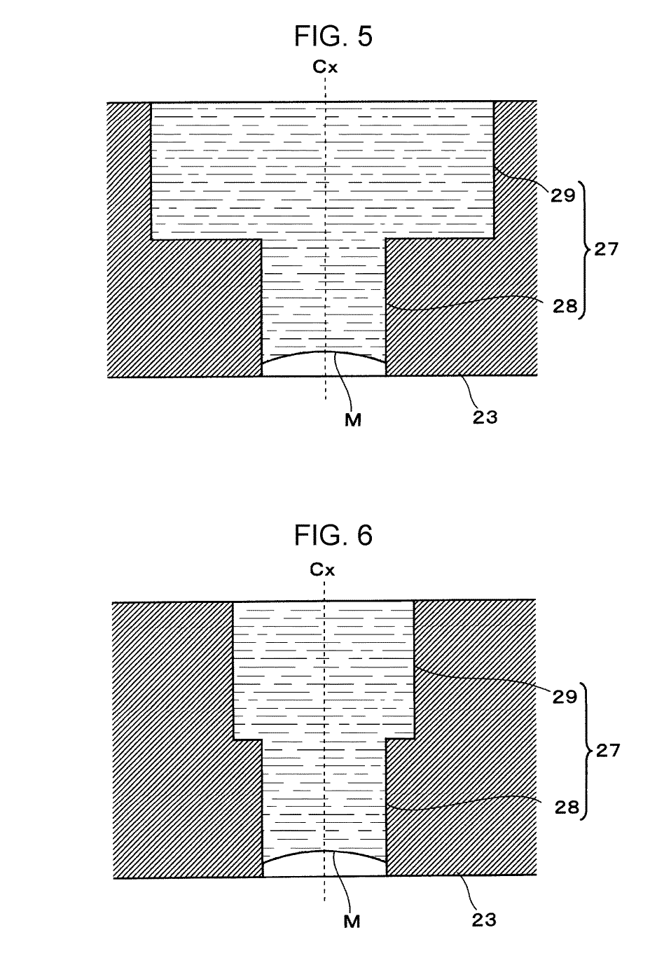

FIG. 4 is a plan view (a top view) of one nozzle 27 when viewed from a virtual center axis Cx. Further, FIG. 5 is a cross-sectional view of the nozzle 27 taken along the line V-V of FIG. 4, and FIG. 6 is a cross-sectional view of the nozzle 27 taken along the line VI-VI of FIG. 4. Here, a portion denoted by M in FIGS. 5 and 6 is a meniscus that is the surface an ink inside the nozzle 27. In this embodiment, the nozzle 27 has a two-stage structure consisting of a first nozzle portion 28 and a second nozzle portion 29. The first nozzle portion 28 is a nozzle portion disposed at a side from which ink droplets are discharged. The second nozzle portion 29 is a nozzle portion disposed at an inlet side into which an ink from a pressure chamber 31, described later, is flown. The first nozzle portion 28 and the second nozzle portion 29 have mutually different flow-path cross-sectional shapes (cross-sectional shapes spreading in a direction perpendicular to the virtual center axis). The second nozzle portion 29 has a larger flow-path cross-sectional area than that of the first nozzle portion 28, and has an elliptical shape in a plan view, that is, when viewed from the virtual center axis Cx of the nozzle 27. Meanwhile, the first nozzle portion 28 has a perfectly circular shape in the plan view. Further, the first nozzle portion 28 is disposed coaxially with the second nozzle portion 29, and is encompassed within the scope of the second nozzle portion 29 in a plan view. Ink droplets (one kind of liquid droplets) are discharged from an opening at an opposite side of the first nozzle portion 28 from the second nozzle portion 29 side. Here, different shapes mean shapes not including similar shapes having mutually different sizes. Further, the perfectly circular shape means a shape including not only a perfectly circular shape, but also a slightly incomplete, perfectly circular shape. That is, any circular shape having a circularity that can be generally recognized as an approximately, perfectly circular shape in a plan view is included in the perfectly circular shape.

Such nozzles 27 are formed by, for example, dry edging. Specifically, first, anisotropic dry etching using a photomask applied to the first nozzle portions 28 is performed on a silicon substrate that is a base material of the nozzle plate 23, and as a result, penetration holes each associated with a corresponding one of the first nozzle portions 28 are formed. After the removal of a resist pattern on the surface of the silicon substrate, subsequently, dry etching using a photomask applied to the second nozzle portions 29 is performed from the face of one side of the silicon substrate until the depth of the dry etching comes to a depth equal to the height of each of the second nozzle portions 29. Through these processes, the nozzles 27, each consisting of the second nozzle portion 29 and the first nozzle portion 28, which have mutually different shapes, are formed. Here, a method that allows etching from the face of one side of the silicon substrate to be performed to form the second nozzle portions 29, and allows etching from the face of the other side of the silicon substrate to be performed to form the first nozzle portions 28 may be employed.

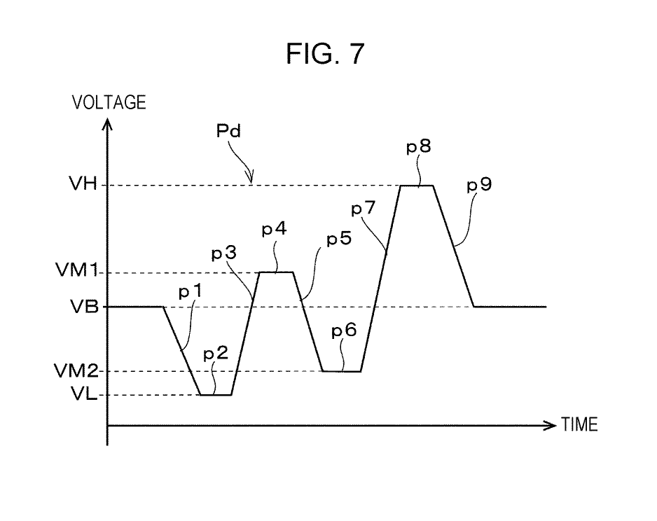

In the flow path substrate 24, there are formed a plurality of space portions each serving as the pressure chamber 31 and associated with a corresponding one of the nozzles 27. Further, a common liquid chamber 32 is formed at the outside of each of rows of the pressure chambers 31 in the flow path substrate 24. The common liquid chamber 32 is a space portion common to the each of rows of the pressure chambers 31. The common liquid chamber 32 individually communicates with each of the pressure chambers 31 through a corresponding one of ink supply ports 33. Here, the pressure chamber 31 and the ink supply opening 33, which individually communicate with each of the nozzles 27, correspond to the liquid flow path in the invention. Further, an ink from the ink cartridge side is introduced to each of the common liquid chambers 32 through a corresponding one of ink introduction paths 34. Further, the piezoelectric elements 25 (one kind of the driving elements in the invention) are formed on an upper face of the flow path substrate 24, that is, a face at the opposite side of the flow path substrate 24 from the nozzle plate 23. Each of the piezoelectric elements 25 is formed by sequentially stacking a metallic lower electrode film, a piezoelectric material layer made of, for example, lead zirconate titanate, and a metallic upper electrode film (these components being not illustrated). Each of the piezoelectric elements 25 is a so-called bending-mode piezoelectric element, and is formed so as to cover the upper portion of a corresponding one of the pressure chambers 31. Each of the piezoelectric elements 25 is deformed by being supplied with a driving signal (a driving pulse Pd (see FIG. 7)) through a corresponding one of wiring members 36. With this deformation of each of the piezoelectric elements 25, a pressure vibration occurs in an ink contained in a corresponding one of the pressure chambers 31, and control of this pressure vibration of the ink allows the ink to be discharged from a corresponding one of the nozzles 27.

The printer 1, according to this embodiment of the invention, is configured to reduce the occurrence of the tail of an ink droplet discharged from each of the nozzles 27 of the recording head 2, which is configured in such a way as described above. Hereinafter, this reduction of the occurrence of the tail will be described.

FIG. 7 is a waveform diagram of an example of the driving pulse Pd. The driving pulse Pd allows a very minute ink droplet (a small dot) among some sizes of ink droplets dischargeable from each of the nozzles 27 of the recording head 2 to be discharged. In this embodiment, the driving pulse Pd includes a first expansion element p1 (one kind of the first drawing element in the invention), a first expansion holding element p2, a first contraction element p3 (one kind of the first pushing-out element), a first contraction holding element p4, a second expansion element p5 (one kind of the second drawing element in the aspect of the invention), a second expansion holding element p6, a second contraction element p7 (one kind of the second pushing-out element in the aspect of the invention), a second contraction holding element p8, and a recovery expansion element p9. The first expansion element p1 is a waveform element in which an electric potential changes (descends) to a minus side (a first polarity side) at a constant gradient from a referential electric potential VB up to an expansion electric potential VL lower than the referential electric potential VB. The first expansion holding element p2 is a waveform element in which the expansion electric potential VL, which is a termination electric potential of the first expansion element p1, is held during a constant period of time. The first contraction element p3 is a waveform element in which the electric potential changes (ascends) to a plus side (a first polarity side) from the expansion electric potential VL up to a first intermediate contraction electric potential VM1 higher than the reference electric potential VB. The first contraction holding element p4 is a waveform in which the first intermediate contraction electric potential VM1 is held during a constant period of time. The second expansion element p5 is a waveform element in which the electric potential descends again from the first intermediate contraction electric potential VM1 up to a second intermediate electric potential VM2 lower than the reference electric potential VB. The second expansion holding element p6 is a waveform in which the second intermediate electric potential VM2 is held during a constant period of time. The second contraction element p7 is a waveform element in which the electric potential changes to the plus side from the second intermediate electric potential VM2 up to a contraction electric potential VH higher than the first intermediate contraction electric potential VM1. The second contraction holding element p8 is a waveform in which the contraction electric potential VH is held during a constant period of time. The recovery expansion element p9 is a waveform element in which the electric potential recovers from the contraction electric potential VH up to the reference electric potential VB.

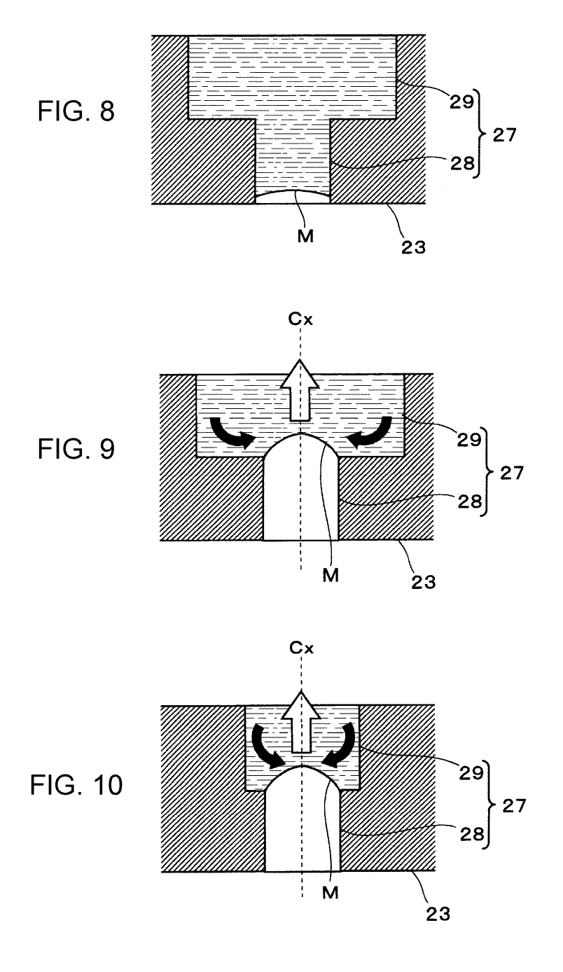

FIGS. 8 to 16 are diagrams illustrating a process in which an ink droplet is discharged from a nozzle 27. Here, among these figures, FIG. 10 is a figure corresponding to a cross-sectional view taken along the line VI-VI of FIG. 4, and the other figures are figures corresponding to a cross-sectional view taken along the V-V line of FIG. 4. FIG. 8 indicates a state of the inside of the nozzle 27 before the driving pule Pd is applied to the piezoelectric element 25 (i.e., a state before the discharge of an ink). In this state, the reference electric potential VB is continuously applied to the piezoelectric element 25, and any pressure change caused by driving of the piezoelectric element 25 does not occur inside the pressure chamber 31. Thus, the meniscus M, inside the nozzle 27, is waiting at an initial position (a reference position) adjacent to the opening at the discharge side of the first nozzle portion 28. When, in this state, the driving pulse Pd, which is configured in such a way as described above, is applied to the piezoelectric element 25, first, the first expansion element p1 causes the piezoelectric element 25 to bend toward the outside of the pressure chamber 31 (i.e., in a direction away from the nozzle 27), and with this bending of the piezoelectric element 25 toward the outside of the pressure chamber 31, the pressure chamber 31 expands from a reference volume corresponding to the reference electric potential VB to a first expansion volume corresponding to the expansion electric potential VL (a first expansion step). This expansion of the pressure chamber 31 causes the meniscus M in the nozzle 27 to be largely drawn toward the pressure chamber 31 side (i.e., toward the upper side in FIGS. 9 and 10) as shown in FIGS. 9 and 10. That is, the meniscus M moves from the first nozzle portion 28 side toward the second nozzle portion 29 side.

At this time, at least part of the meniscus M is drawn to a degree exceeding the boundary portion between the first nozzle portion 28 and the nozzle portion 29. As described above, the second nozzle portion 29 and the first nozzle portion 28, which constitute the nozzle 27, have mutually different shapes, and further, the second nozzle portion 29 has an elliptical shape. Thus, in the nozzle 27, according to this embodiment, the operation of allowing the meniscus M to reciprocate between the second nozzle portion 29 and the first nozzle portion 28 relative to the initial position causes a complicated flow in the ink inside the nozzle 27, as compared with a conventional nozzle constituted by one or more cylinders each having a perfectly circular shaped, cross-sectional shape (the structure of the cylinders including a plurality of stages of cylinders having mutually different cross-sectional shapes), and this complicated flow in the ink excites a complicated vibration of the ink. That is, in this embodiment, the way of ink flow in a step difference portion extending in a long-diameter direction of the second nozzle portion 29 and located between the first nozzle portion 28 and the second nozzle portion 29 (see FIG. 9) is different from the way of ink flow in a step difference portion extending in a short-diameter direction of the second nozzle portion 29 and located between the first nozzle portion 28 and the second nozzle portion 29 (see FIG. 10). Here, the way of ink flow means the direction and the speed of flow of the ink, and is denoted by black arrows in each of FIGS. 9 and 10.

More specifically, as shown in FIG. 9, in the step difference portion extending in the long-diameter direction of the second nozzle portion 29, the area of the face of the step difference portion is relatively large and the distance from the inner circumstance face of the second nozzle portion 29 to the opening at the inlet side of the first nozzle portion 28 is relatively long. For this reason, in the step difference portion extending in the long-diameter direction of the second nozzle portion 29, the speed of flow of the ink is relatively slow and the angle of the direction of flow of the ink relative to the virtual center axis Cx is relatively large. In contrast thereto, as shown in FIG. 10, in the step difference portion extending in the short-diameter direction of the second nozzle portion 29, the area of the face of the step difference portion is relatively small and the distance from the inner circumstance face of the second nozzle portion 29 to the opening at the inlet side of the first nozzle portion 28 is relatively short. For this reason, in the step difference portion extending in the short-diameter direction of the second nozzle portion 29, the speed of flow of the ink is relatively fast and the angle of the direction of flow of the ink relative to the virtual center axis Cx is so small that the direction of the flow of ink is nearly parallel to the virtual center axis Cx. In this way, the nonuniform flow of the ink is actively caused in a portion adjacent to the boundary between the second nozzle portion 29 and the first nozzle portion 28 to excite a further complicated vibration of the ink inside the nozzle 27. Hereinafter, the vibration excited in such a way as described above will be referred to as a swing mode. Further, this expansion state of the pressure chamber 31 is held by the first expansion holding element p2 during a predetermined period of time (a first expansion holding step).

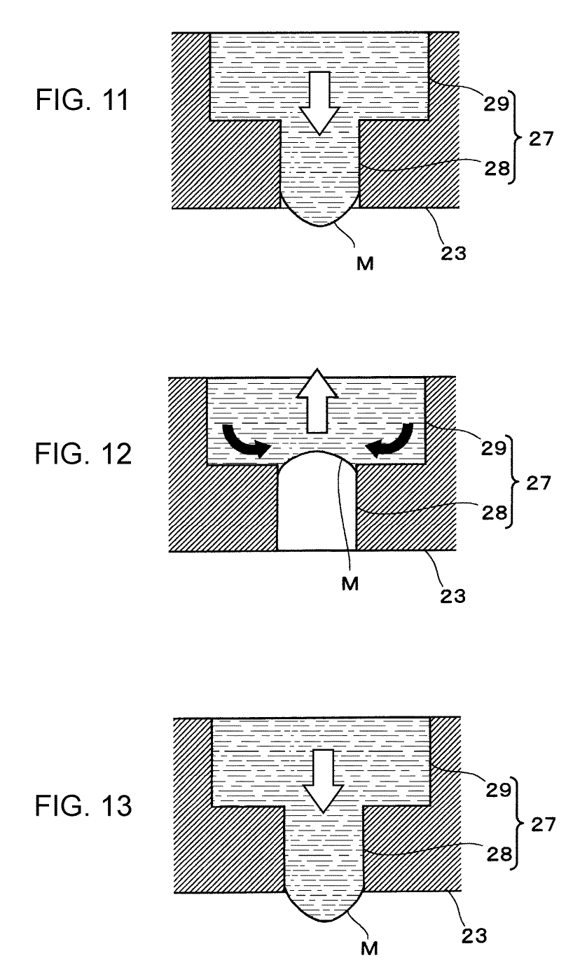

After this holding by the first expansion holding element p2, the piezoelectric element 25 is caused to bend toward the inside of the pressure chamber 31 (i.e., in a direction approaching the nozzle 27) by the first contraction element p3. With this bending of the piezoelectric element 25 toward the inside of the pressure chamber 31, the pressure chamber 31 is caused to contract from the first expansion volume to a first intermediate contraction volume corresponding to the first intermediate contraction electric potential VM1 (a first contraction step). With this contraction of the pressure chamber 31, as shown in FIG. 11, a pressure is applied to the ink inside of the pressure chamber 31, and the meniscus M is pushed out toward the discharge side (the lower side in FIG. 11). Subsequently, the first contraction holding element p4 is supplied to the piezoelectric element 25 to cause the contraction state of the pressure chamber 31 to be held during a predetermined period of time (a first contraction holding step). Subsequently, the second expansion element p5 is supplied to the piezoelectric element 25 to cause the piezoelectric element 25 to bend toward the outside of the pressure chamber 31. With this bending of the piezoelectric element 25 toward the outside of the pressure chamber 31, the pressure chamber 31 expands again from the intermediate contraction volume to a second expansion volume corresponding to the second intermediate electric potential VM2 (a second expansion process). With this expansion of the pressure chamber 31, as shown in FIG. 12, the meniscus M is drawn again toward the pressure chamber 31 side. That is, the meniscus M moves from the first nozzle portion 28 side toward the second nozzle portion 29 side. At this time, similarly to the first expansion step, at least part of the meniscus M is drawn to a degree exceeding the boundary portion between the first nozzle portion 28 and the second nozzle portion 29. With this operation, as described above, the above swing mode is excited in the ink inside the nozzle 27. That is, the driving pulse Pd in this embodiment causes totally two reciprocating operations of the meniscus M across the boundary portion between the first nozzle portion 28 and the second nozzle portion 29 to be performed during one ink discharge process so as to enable a further complicated swing mode to occur in the ink. The expansion state of the pressure chamber 31 is held by the second expansion holding element p6 during a predetermined period of time (a second expansion holding process).

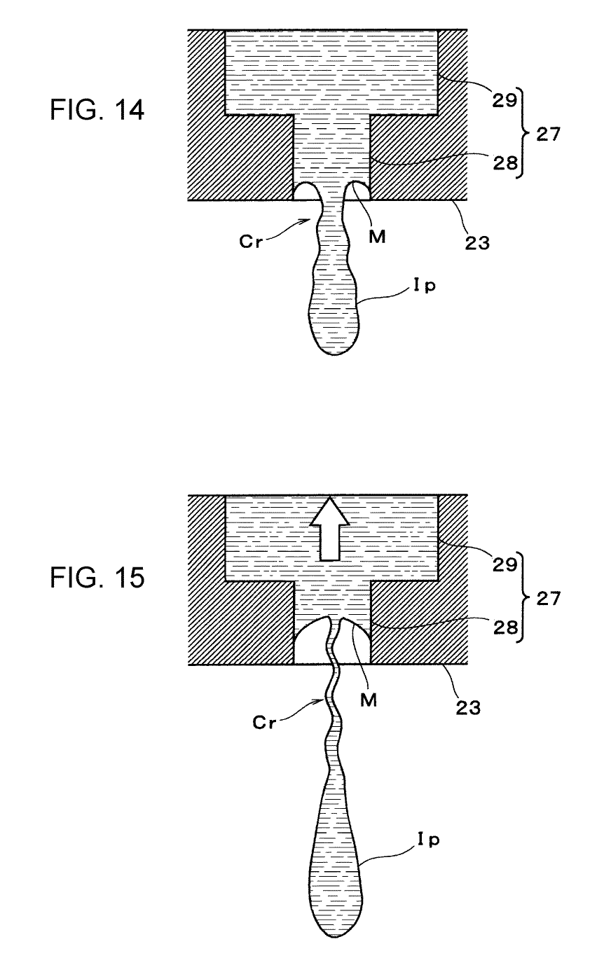

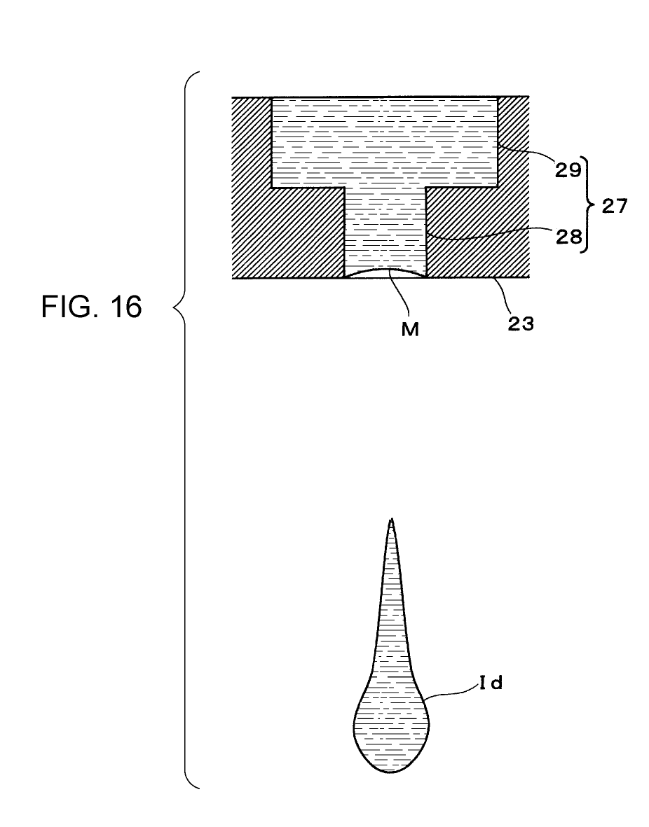

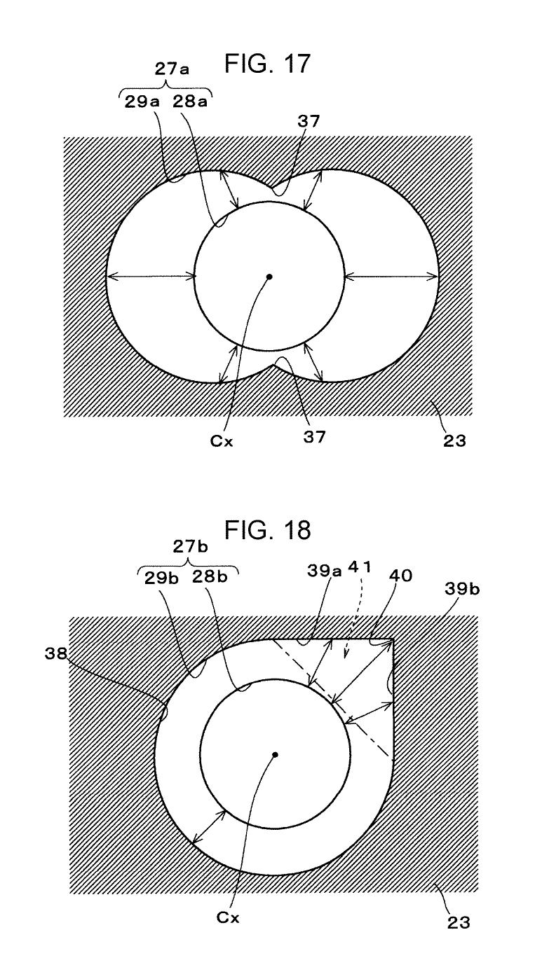

After the second expansion holding step, the piezoelectric element 25 is caused to further largely bend toward the inside of the pressure chamber 31 by the second contraction element p7. With this bending of the piezoelectric element 25 toward the inside of the pressure chamber 31, the pressure chamber 31 is caused to drastically contract from the second expansion volume to a contraction volume corresponding to the contraction electric potential VH (a second contraction step). With this contraction of the pressure chamber 31, as shown in FIG. 13, a pressure is applied to the ink inside of the pressure chamber 31 and the meniscus M is pushed out toward the discharge side. The contracted state of the pressure chamber 31 is held during a predetermined period of time by the second contraction holding element p8 (a second contraction holding step). During this period of time, as shown in FIG. 14, the center portion of the meniscus M is elongated by the force of inertia just like a liquid column. Here, a narrow portion Cr is generated between the end portion of the liquid column Ip (a portion that becomes an ink droplet) and the meniscus M. This narrow portion Cr is narrower than the end portion of the liquid column Ip. As described above, since the ink inside the nozzle 27 is caused to reciprocate between the second nozzle portion 29 and the first nozzle portion 28 to excite the swing mode in the ink inside the nozzle 27, the narrow portion Cr is caused to swing by the swing mode (that is, the narrow portion Cr is brought into an unstable state). After the second contraction holding element p8, the recovery expansion element p9 is applied to the piezoelectric element 25, and the piezoelectric element 25 is displaced up to the reference position. With this displacement of the piezoelectric element 25 up to the reference position, the pressure chamber 31 is caused to expand from the contraction volume to the reference volume. As shown in FIG. 15, in a state in which the liquid column Ip is being elongated in the discharge direction by the force of inertia, the meniscus is drawn in a direction reverse to the discharge direction, and thus, the narrow portion Cr is further thinly elongated. Moreover, the liquid column Ip is caused to swing by the swing mode, and thus, the liquid column Ip is separated from the meniscus M at the narrow portion Cr in an earlier stage than in a conventional method. Further, as shown in FIG. 16, the separated portion flies toward the recording medium as one ink droplet Id.

In this way, in a process in which one ink droplet is discharged from the nozzle 27, at least part of the meniscus M reciprocates across the boundary between the second nozzle portion 29 and the first nozzle portion 28, which have mutually different flow-path cross-sectional shapes, relative to the initial position one or more times, and as a result, a further complicated vibration mode (the swing mode) is excited in the ink. With this operation, the narrow portion Cr, which is a portion between the meniscus M and a head portion that becomes the ink droplet Id after the discharge from the nozzle 27, is caused to swing so as to be further cuttable. This configuration reduces the occurrence of the tail of the ink droplet Id having been discharged from the nozzle 27, and thus reduces the occurrence of the satellite liquid droplet and the occurrence of the mists. As a result, the degradation of the quality of recorded images on the recording medium and the stains of the inside of the printer 1 due to the mists are reduced. Further, in this embodiment, the first nozzle portion 28 has a perfectly circular shape in a plan view, and thus, even when the second nozzle portion 29 does not have a perfectly circular shape (the second nozzle portion 29 has an elliptical shape in this embodiment), the shape of a portion to be discharged as an ink droplet (the end portion of the liquid column Ip) is stable. As a result, the deviation of the flying direction of the ink droplet from an intended direction is reduced and thus, the flying direction of the ink droplet is stable. Accordingly, the degradation of accuracy of the landing of the ink droplet on the recording medium is reduced. Further, the configuration in which the whole of the first nozzle portion 28 is encompassed within the scope of the second nozzle portion 29 in a plan view realizes the stabilization of the flying directions of the ink droplets, and thus contributes to maintaining accuracy of the landings of the ink droplets.

Next, other embodiments according to the invention will be described.

FIG. 17 is a plan view of a nozzle 27a, a nozzle according to a second embodiment of the invention. The nozzle 27a, according to this embodiment, is constituted by a second nozzle portion 29a and a first nozzle portion 28a, and the flow path of the second nozzle portion 29a and the flow path of the first nozzle portion 28a have mutually different cross-sectional shapes. The second nozzle portion 29a, according to this embodiment, has a shape resulting from coupling two perfect circles so as to allow the two perfect circles to partially overlap with each other in a plan view. With this configuration, in addition to a curved face having a circular arc shape, two apex end portions 37 are formed on the inner periphery face of the second nozzle portion 29a. The two apex end portions 37 protrude toward the inside of the second nozzle portion 29a, that is, toward the side of the center of gravity of the second nozzle portion 29a, in a plan view. Meanwhile, the first nozzle portion 28a has a perfectly circular shape in a plan view, just like the first nozzle portion 28 in the above first embodiment. Further, the whole of the first nozzle portion 28a is encompassed within the scope of the second nozzle portion 29b in a plan view, and a virtual center axis Cx of the first nozzle portion 28a is placed on the center of gravity of the second nozzle portion 29b. In this way, in this embodiment, as shown by arrows in FIG. 17, the distance from the inner periphery face of the second nozzle portion 29a to the edge of the opening at the inlet side (the second nozzle portion 29a side) of the first nozzle portion 28a (i.e. the step difference distance) is not uniform, and the inner periphery face of the second nozzle portion 29a, most of which is constituted by a curved face, partially includes the apex end portions 37, which protrude toward the inside. Thus, for the curved face portion and each of the apex end portions 37, there is a difference in the way of ink flow. With this configuration, a more complicated ink flow than that in the case of the above nozzle 27 occurs in a portion adjacent to the boundary between the second nozzle portion 29a and the first nozzle portion 28a, and as a result, a further complicated swing mode is exited during an ink discharge process. With this operation, the tail of an ink droplet having been discharged from the nozzle 27a is made more cuttable, and thus, the occurrence of the satellite liquid droplet and the occurrence of the mists are more effectively reduced. Here, the shape of the second nozzle portion 29b is not limited to the exemplified shape, and brings about the same effects, provided that the second nozzle portion 29b is configured to, on its inner periphery face, include at least one protruding portion (for example, ribs) other than the curved portion, just like the apex end portion 37. Further, the protruding portion, such as the apex end portion 37, is not limited to the exemplified two protruding portions, but may be formed at one or each of three or more portions. Further, configurations other than the above-described configuration are the same as those of the above first embodiment.

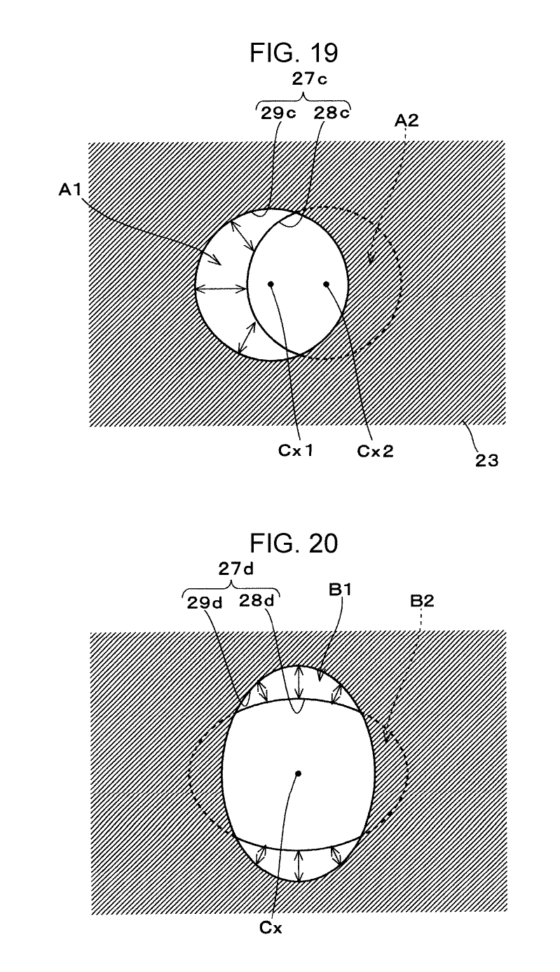

FIG. 18 is a plan view of a nozzle 27b, a nozzle according to a third embodiment of the invention. In this third embodiment, a second nozzle portion 29b includes a curved face portion 38 and two planar face portions 39a and 39b. The curved face portion 38 has a circular ark shape, and the two planar face portions 39a and 39b intersects with each other. Further, in the second nozzle portion 29b, a corner portion 40 is formed at a portion where the planar face portions 39a and 39b intersects with each other. That is, in addition to the curved portion 38, which is smoothly continuously curved, a depressed portion 41 (a portion enclosed by the planar face portions 39a and 39b and a virtual line denoted by an alternate long and short dash line in FIG. 18) is formed on the inner periphery face of the second nozzle portion 29b. The depressed portion 41 is a portion having a triangular shape in a plan view and concaved outward (i.e., toward a side away from the center of gravity). Meanwhile, the first nozzle portion 28b in this embodiment has a perfectly circular shape in a plan view just like the first nozzle portion 28 in the above first embodiment. Further, the whole of the first nozzle portion 28b is encompassed within the scope of the second nozzle portion 29b in a plan view. In this way, in this embodiment, the inner periphery face of the second nozzle portion 29b has the depressed portion 41, which is concaved outward, and thus, for the curved face portion side and the depressed portion 41, there is a difference in the way of ink flow. Additionally, the step difference distance from the inner periphery face of the second nozzle portion 29b to the opening periphery of the first nozzle portion 28b is not uniform, and thus, for a portion where the step difference distance is relatively long and a portion where the step difference distance is relatively short, there is a difference in the way of ink flow. With this configuration, a more complicated ink flow than that in the case of the above second nozzle portion 29 occurs in a portion adjacent to the boundary between the second nozzle portion 29b and the first nozzle portion 28b, and as a result, a further complicated swing mode is exited during an ink discharge process. With this operation, the tail of an ink droplet having been discharged from the nozzle 27b is made more cuttable, and thus, the occurrence of the satellite liquid droplet and the occurrence of the mists are more effectively reduced. Here, the shape of the second nozzle portion 29b is not limited to the exemplified shape, and brings about the same effects, provided that the second nozzle portion 29b is configured to, on its inner periphery face, include a concaved portion (for example, a groove) other than the curved portion, just like the depressed portion 41. Further, the concaved portion, such as the depressed portion 41, is not limited one exemplified portion, but may be formed at each of two or more portions. Further, configurations other than the above-described configuration are the same as those of the above first embodiment.

FIG. 19 is a plan view of a nozzle 27c, a nozzle according to a fourth embodiment of the invention. In each of the above embodiments, the configuration in which the flow path of the first nozzle portion and the flow path of the second nozzle portion have mutually different cross-sectional shapes has been exemplified, but the configuration of the first and second nozzle portions is not limited to such a configuration. In this embodiment, the nozzle 27c includes a second nozzle portion 29c and a first nozzle portion 28c, and the flow path of the second nozzle portion 29c and the flow path of the first nozzle portion 28c have the same size (the same cross-sectional area) and perfectly circular shapes. Further, the second nozzle portion 29c and the first nozzle portion 28c are formed so as to be eccentric, that is, so as to cause their respective virtual center axes Cx1 and Cx2 not to correspond to each other in a plan view. That is, the second nozzle portion 29c and the first nozzle portion 28c partially include a region A1 and a region A2, respectively, and the region A1 and the region A2 are regions not overlapping each other (i.e., regions between which a step difference arises) when viewed in a direction along each of the virtual center axis Cx1 of the second nozzle portion 29c and the virtual center axis Cx2 of the first nozzle portion 28c. In the nozzle 27c, which is configured in such a way as described above, for the regions A1 and A2 and the other region (i.e., a region in which the first nozzle portion 28c and the second nozzle portion 29c overlap each other, and any step difference does not exist), there is a difference in the way of ink flow. That is, in the regions A1 and A2, the speed of the flow of ink is slower than that in the other region, and the direction of the flow of ink is a lateral direction whose angle to the virtual center axes Cx1 and Cx2 is large. Additionally, for the step difference faces of the regions A1 and A2, the step difference distance from the inner periphery face of the second nozzle portion 29c to the inlet side opening of the first nozzle portion 28c is not uniform, and thus, for a portion where the step difference distance is relatively long and a portion where the step difference distance is relatively short, there is a difference in the way of ink flow. With this configuration, a more complicated ink flow than that in the case of the above second nozzle portion 29 in the first embodiment occurs in a portion adjacent to the boundary between the second nozzle portion 29c and the first nozzle portion 28c, and as a result, a further complicated swing mode is exited during an ink discharge process. With this operation, the tail of an ink droplet having been discharged from the nozzle 27c is made more cuttable, and thus, the occurrence of the satellite liquid droplet and the occurrence the mists are more effectively reduced. Here, the nozzle 27c, which includes the second nozzle portion 29c and the first nozzle portion 28c, which partially include their respective portions not overlapping with each other when viewed in a direction along a virtual center axis Cx, is capable of being formed by forming the second nozzle portion 29c from one face of a silicon substrate constituting the nozzle plate 23 up to an intermediate portion in a plate thickness direction of the silicon substrate, forming the first nozzle portion 28c from the other face of the silicon substrate up to the intermediate portion in the plate thickness direction of the silicon substrate, and coupling both of the second nozzle portion 29c and the first nozzle portion 28c. Further, configurations other than the above-described configuration are the same as those of the above first embodiment.

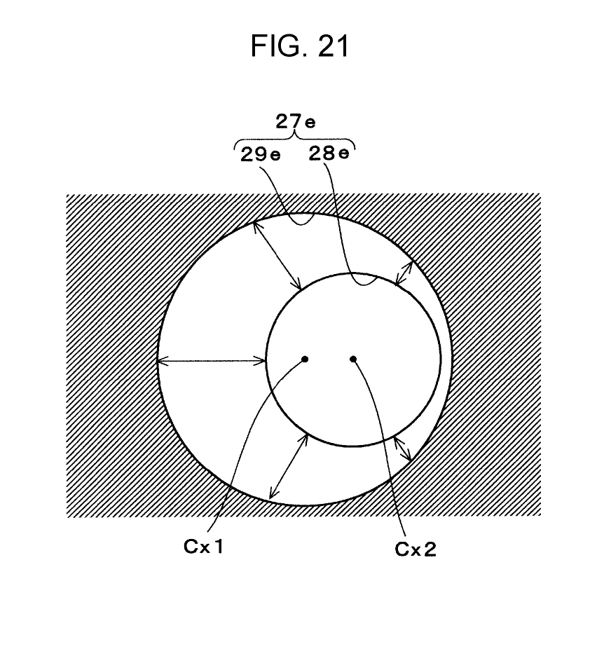

FIG. 20 is a plan view of a nozzle 27d, a nozzle according to a fifth embodiment of the invention. In the above fourth embodiment, the configuration in which both of the flow path of the first nozzle portion 28c and the flow path of the second nozzle portion 29c have perfectly circular shapes has been exemplified, but the configuration of the first nozzle portion 28c and the second nozzle portion 29c is not limited to such a configuration. In this embodiment, the nozzle 27d includes a second nozzle portion 29d and a first nozzle portion 28d, and the flow path of the second nozzle portion 29d and the flow path of the first nozzle portion 28d have the same size and elliptical shapes. Further, the second nozzle portion 29d and the first nozzle portion 28d are formed so as to allow their respective long-axis directions to intersect each other with 90 degrees at a virtual center axis Cx in a plan view. That is, the second nozzle portion 29d and the first nozzle portion 28d partially include a region B1 and a region B2, respectively, and the region B1 and the region B2 are regions not overlapping with each other (i.e., step difference regions) when viewed in a direction along the virtual center axis Cx of each of the nozzle portions. In the nozzle 27d, which is configured in such a way as described above, just like the regions A1 and A2 in the above fourth embodiment, for the regions B1 and B2 and the other region (i.e., a region in which the regions B1 and B2 overlap with each other, there is a difference in the way of ink flow. With this configuration, a more complicated ink flow than that in the case of the above second nozzle portion 29 in the first embodiment occurs in a portion adjacent to the boundary between the second nozzle portion 29d and the first nozzle portion 28d, and as a result, a further complicated swing mode is exited during an ink discharge process. With this operation, the tail of an ink droplet having been discharged from the nozzle 27d is made more cuttable, and thus, the occurrence of the satellite liquid droplet and the occurrence of the mists are more effectively reduced. Further, configurations other than the above-described configuration are the same as those of the above first embodiment.

FIG. 21 is a plan view of a nozzle 27e, a nozzle according to a sixth embodiment of the invention. In this embodiment, the nozzle 27e includes a second nozzle portion 29e and a first nozzle portion 28e, and the flow path of the second nozzle portion 29e and the flow path of the first nozzle portion 28e have perfectly circular shapes. That is, the second nozzle portion 29e has a perfectly circular shape whose flow path has a relatively large cross-sectional area, and the first nozzle portion 29c has a perfectly circular shape whose flow path has a relatively small cross-sectional area. Further, the second nozzle portion 29e and the first nozzle portion 28e are formed so as to be eccentric, that is, so as to cause their respective virtual center axes Cx1 and Cx2 not to correspond to each other in a plan view, and further, the whole of the first nozzle portion 28e is encompassed within a scope of the second nozzle portion 29e. In this way, the second nozzle portion 29e and the first nozzle portion 28e are formed so as to be eccentric to each other in a state in which the whole of the first nozzle portion 28e is encompassed within the scope of the second nozzle portion 29e so as to cause the step difference distance from the inner periphery face of the second nozzle portion 29e to the opening periphery of the first nozzle portion 28e to be nonuniform, and thus, for a portion where the step difference distance is relatively long and a portion where the step difference distance is relatively short, there is a difference in the way of ink flow. That is, in the portion where the step difference distance is relatively long, the speed of the flow of ink is relatively slow, and the direction of the flow of ink is a lateral direction whose angle to the virtual center axes Cx1 and Cx2 is fairly large. In contrast thereto, in the portion where the step difference distance is relatively short, the speed of the flow of ink is relatively fast, and the direction of the flow of ink is a direction whose angle to the virtual center axes Cx1 and Cx2 is so small that the direction of the flow of ink is nearly parallel to the virtual center axes Cx1 and Cx2. With this configuration, a more complicated ink flow than that in the case of the above second nozzle portion 29 in the first embodiment occurs in a portion adjacent to the boundary between the second nozzle portion 29e and the first nozzle portion 28e, and as a result, a further complicated swing mode is exited during an ink discharge process. With this operation, the tail of an ink droplet having been discharged from the nozzle 27e is made more cuttable, and thus, the occurrence of the satellite liquid droplet and the occurrence of the mists are more effectively reduced. Here, the cross-sectional shapes of the flow paths of the second nozzle portion 29e and the first nozzle portion 28e are not limited to the perfectly circular shapes, but are just required to be similar shapes, allow the whole of the first nozzle portion to be encompassed within the scope of the second nozzle portion, and be configured to allow the second nozzle portion 29e and the first nozzle portion 28e to be disposed so as to be eccentric to each other, and for example, the shapes of the nozzle portions 28e and 29e may be elliptical shapes. Further, configurations other than the above-described configuration are the same as those of the above first embodiment.

Here, in each of the above embodiments, a nozzle configured to have a structure of two stages has been exemplified, but the configuration is not limited this configuration, and a nozzle configured to have a structure of three or more stages may be employed. That is, a configuration in which one or more other nozzles that are formed between the first nozzle portion and the second nozzle portion so as to allow the first nozzle portion and the second nozzle portion to communicate with each other may be employed. In this case, a configuration that allows the nozzle portions to be eccentric to one another or a configuration that allows the flow paths of the nozzle portions to have mutually cross-sectional shapes enables the swing mode be excited in the ink at boundaries between every two adjacent nozzle portions among the nozzle portions. Moreover, a nozzle having a multi-stage structure in which two or more stages of nozzle portions are formed, and having a taper shape in which the inner wall face of the nozzle is inclined so as to, when an observed nozzle portion among the nozzle portions sequentially sifts from a nozzle portion at the discharge side toward a nozzle portion closest to the pressure chamber side (the liquid flow path side), allow the inner diameter of the observed nozzle portion to increase step-by-step may be employed.

Further, the driving pulse is not limited to the driving pulse Pd having been exemplified in FIG. 7, but any kind of driving pulse that drives a driving element so as to allow at least part of a meniscus inside a nozzle to reciprocate across the boundary between the first nozzle portion and the second nozzle portion one or more times, and to allow an ink droplet to be discharged from the nozzle can be employed. For example, a driving pulse that allows at least part of a meniscus to reciprocate across the first nozzle portion and the second nozzle portion totally three or more times, and then allows an ink droplet to be discharged from the nozzle may be employed.

Further, in each of the above embodiments, the piezoelectric element 25, being of a so-called bending vibration type, has been exemplified, but without limited to this type, a piezoelectric element of a so-called vertical vibration type can be employed. In this case, a driving pulse has a waveform in which its electric-potential change direction, that is, its upper and lower (i.e., the polarity), is reverse to that of the driving pulse Pd having been exemplified in each of the above embodiments is used.

Further, the invention can be applied to, not only the above printer 1, but also various ink jet recording apparatuses such as a plotter, a facsimile machine, and a copy machine, and liquid discharge apparatuses such as a printing apparatus that performs printing by allowing inks to be discharged from a liquid discharge head and be landed on cloth (a print target material) that is one kind of landing targets.

The entire disclosure of Japanese Patent Application No. 2016-046603, filed Mar. 10, 2016 is expressly incorporated by reference herein.

What is claimed is:

1. A liquid discharge head comprising:
a liquid flow path; and
a nozzle communicating with the liquid flow path and configured to allow a liquid flown in via the liquid flow path to be discharged from the nozzle itself,
wherein the nozzle includes a first nozzle portion at a side at which the liquid is discharged, and a second nozzle portion at a side of the liquid flow path,
wherein the first nozzle portion and the second nozzle portion respectively include a first partial region and a second partial region that do not overlap each other when viewed in a liquid discharge direction in which the liquid is discharged, and
wherein after at least one portion of a meniscus inside the nozzle has reciprocated across a boundary between the first nozzle portion and the second nozzle portion one or more times, a liquid droplet is discharged from the nozzle.

2. The liquid discharge head according to claim 1, wherein a virtual center axis along the liquid discharge direction in the first nozzle portion is located within a scope of the second nozzle portion when viewed in the liquid discharge direction.

3. A liquid discharge head comprising:
a liquid flow path; and
a nozzle communicating with the liquid flow path and configured to allow a liquid flown in via the liquid flow path to be discharged from the nozzle itself,
wherein the nozzle includes a first nozzle portion at a side at which the liquid is discharged, and a second nozzle portion at a side of the liquid flow path,
wherein a flow path of the first nozzle portion and a flow path of the second nozzle portion include mutually different cross-sectional shapes when viewed in a liquid discharge direction in which the liquid is discharged, and
wherein after at least one portion of a meniscus inside the nozzle has reciprocated across a boundary between the first nozzle portion and the second nozzle portion one or more times, a liquid droplet is discharged from the nozzle.

4. The liquid discharge head according to claim 3, wherein a whole of the first nozzle portion is located within a scope of the second nozzle portion when viewed in the liquid discharge direction in the first nozzle portion.

5. A liquid discharge head comprising:
a liquid flow path; and
a nozzle communicating with the liquid flow path and configured to allow a liquid flown in via the liquid flow path to be discharged from the nozzle itself,
wherein the nozzle includes a first nozzle portion at a side at which the liquid is discharged, and a second nozzle portion at a side of the liquid flow path,
wherein the first nozzle portion is included within a scope of the second nozzle portion when viewed in a liquid discharge direction in which the liquid is discharged, and the first nozzle portion is eccentric to a virtual center axis along the liquid discharge direction in the second nozzle portion, and
wherein after at least one portion of a meniscus inside the nozzle has reciprocated across a boundary between the first nozzle portion and the second nozzle portion one or more times, a liquid droplet is discharged from the nozzle.

6. The liquid discharge head according to claim 1, wherein a flow path of the first nozzle portion includes a perfectly circular shape when viewed in the liquid discharge direction.

7. A liquid discharge apparatus comprising:
the liquid discharge head according to claim 1;
a driving element configured to cause a pressure vibration in a liquid inside the liquid flow path, which is the liquid flow path of the liquid discharge head; and
a driving pulse generation circuit configured to generate a driving pulse that drives the driving element,
wherein the driving pulse includes a first drawing element that draws at least one portion of the meniscus, which is the meniscus of the liquid discharge head, from a side of the first nozzle portion, which is the first nozzle portion of the liquid discharge head, to a side of the second nozzle portion, which is the second nozzle portion of the liquid discharge head, a first pushing out element that pushes out the meniscus from the first nozzle portion to an outside of the first nozzle portion, a second drawing element that draws again at least one portion of the meniscus from the side of the first nozzle portion to the side of the second nozzle portion, and a second pushing out element that pushes out the meniscus from the first nozzle portion to the outside of the first nozzle portion.

8. A liquid discharge apparatus comprising:
the liquid discharge head according to claim 2;
a driving element configured to cause a pressure vibration in a liquid inside the liquid flow path, which is the liquid flow path of the liquid discharge head; and
a driving pulse generation circuit configured to generate a driving pulse that drives the driving element,
wherein the driving pulse includes a first drawing element that draws at least one portion of the meniscus, which is the meniscus of the liquid discharge head, from a side of the first nozzle portion, which is the first nozzle portion of the liquid discharge head, to a side of the second nozzle portion, which is the second nozzle portion of the liquid discharge head, a first pushing out element that pushes out the meniscus from the first nozzle portion to an outside of the first nozzle portion, a second drawing element that draws again at least one portion of the meniscus from the side of the first nozzle portion to the side of the second nozzle portion, and a second pushing out element that pushes out the meniscus from the first nozzle portion to the outside of the first nozzle portion.

9. A liquid discharge apparatus comprising:
the liquid discharge head according to claim 3;
a driving element configured to cause a pressure vibration in a liquid inside the liquid flow path, which is the liquid flow path of the liquid discharge head; and
a driving pulse generation circuit configured to generate a driving pulse that drives the driving element,
wherein the driving pulse includes a first drawing element that draws at least one portion of the meniscus, which is the meniscus of the liquid discharge head, from a side of the first nozzle portion, which is the first nozzle portion of the liquid discharge head, to a side of the second nozzle portion, which is the second nozzle portion of the liquid discharge head, a first pushing out element that pushes out the meniscus from the first nozzle portion to an outside of the first nozzle portion, a second drawing element that draws again at least one portion of the meniscus from the side of the first nozzle portion to the side of the second nozzle portion, and a second pushing out element that pushes out the meniscus from the first nozzle portion to the outside of the first nozzle portion.

10. A liquid discharge apparatus comprising:
the liquid discharge head according to claim 4;
a driving element configured to cause a pressure vibration in a liquid inside the liquid flow path, which is the liquid flow path of the liquid discharge head; and
a driving pulse generation circuit configured to generate a driving pulse that drives the driving element,
wherein the driving pulse includes a first drawing element that draws at least one portion of the meniscus, which is the meniscus of the liquid discharge head, from a side of the first nozzle portion, which is the first nozzle portion of the liquid discharge head, to a side of the second nozzle portion, which is the second nozzle portion of the liquid discharge head, a first pushing out element that pushes out the meniscus from the first nozzle portion to an outside of the first nozzle portion, a second drawing element that draws again at least one portion of the meniscus from the side of the first nozzle portion to the side of the second nozzle portion, and a second pushing out element that pushes out the meniscus from the first nozzle portion to the outside of the first nozzle portion.

11. A liquid discharge apparatus comprising:
the liquid discharge head according to claim 5;
a driving element configured to cause a pressure vibration in a liquid inside the liquid flow path, which is the liquid flow path of the liquid discharge head; and
a driving pulse generation circuit configured to generate a driving pulse that drives the driving element,
wherein the driving pulse includes a first drawing element that draws at least one portion of the meniscus, which is the meniscus of the liquid discharge head, from a side of the first nozzle portion, which is the first nozzle portion of the liquid discharge head, to a side of the second nozzle portion, which is the second nozzle portion of the liquid discharge head, a first pushing out element that pushes out the meniscus from the first nozzle portion to an outside of the first nozzle portion, a second drawing element that draws again at least one portion of the meniscus from the side of the first nozzle portion to the side of the second nozzle portion, and a second pushing out element that pushes out the meniscus from the first nozzle portion to the outside of the first nozzle portion.

12. A liquid discharge apparatus comprising:
the liquid discharge head according to claim 6;
a driving element configured to cause a pressure vibration in a liquid inside the liquid flow path, which is the liquid flow path of the liquid discharge head; and
a driving pulse generation circuit configured to generate a driving pulse that drives the driving element,
wherein the driving pulse includes a first drawing element that draws at least one portion of the meniscus, which is the meniscus of the liquid discharge head, from a side of the first nozzle portion, which is the first nozzle portion of the liquid discharge head, to a side of the second nozzle portion, which is the second nozzle portion of the liquid discharge head, a first pushing out element that pushes out the meniscus from the first nozzle portion to an outside of the first nozzle portion, a second drawing element that draws again at least one portion of the meniscus from the side of the first nozzle portion to the side of the second nozzle portion, and a second pushing out element that pushes out the meniscus from the first nozzle portion to the outside of the first nozzle portion.
